(19) United States
(12) Patent Application Publication
(10) Pub. No.: US 2021/0059210 A1
(43) Pub. Date: Mar. 4, 2021

(54) ANIMAL KENNEL COVER

(71) Applicant: Doskocil Manufacturing Company, Inc., Arlington, TX (US)

(72) Inventors: Ryan PAXSON, Elk Rapids, MI (US); Sherry HILDEBRAND, Irving, TX (US)

(21) Appl. No.: 17/004,938

(22) Filed: Aug. 27, 2020

Related U.S. Application Data
(60) Provisional application No. 62/892,289, filed on Aug. 27, 2019.

(51) Int. Cl. A01K 1/02; A01K 1/03

(52) U.S. Cl. CPC A01K 1/0245; A01K 1/034

(57) ABSTRACT

A cover for a kennel includes a first side, a second side and a top side. The first side is configured to cover at least a part of a first side of the kennel. The second side is configured to cover at least a part of a second side of the kennel. The top side connects the first side and the second side and is configured to cover a top part of the kennel. At least one of the first side, the second side and the top side includes a storage area.

### CROSS REFERENCE TO RELATED APPLICATIONS

This application claims priority to U.S. Provisional Patent Application No. 62/892,289 filed on Aug. 27, 2019. The entire disclosure of U.S. Provisional Patent Application No. 62/892,289 is hereby incorporated herein by reference.

### BACKGROUND

### Field of the Invention

The present invention relates to a pet kennel or carrier cover. In particular, the present invention relates to covers that improve the aesthetics and usefulness or a pet kennel or carrier.

### Background of the Invention

Conventional carriers or kennels can be plastic and are typically viewed as a travel accessory for dogs and cats. Conventional kennels or carriers can also be used to contain a pet in the home for training, to confine an animal for daily use to prevent destruction or other dangerous behaviors, sleeping, separation from multiple pets during mealtimes. Additionally, some veterinarians and behaviorists recommend using kennels everyday to emulate a den or home.

### SUMMARY

As can be understood, plastic kennels come in a wide variety of sizes and colors. Many kennels tend to appear utilitarian and not home décor friendly. That is, many kennels are made of plastic, are durable, have a wire door, nuts and bolts on the rim, etc. It has been found that an improved décor for kennels is desired. Embodiments of the present invention can create a home décor friendly cover intended to help the utilitarian kennel blend to home décor seamlessly, while covering with fabrics typically used for home furnishings and accessories.

Embodiments of the present invention provide a cover for a kennel includes a first side, a second side and a top side. The first side is configured to cover at least a part of a first side of the kennel. The second side is configured to cover at least a part of a second side of the kennel. The top side connects the first side and the second side and is configured to cover a top part of the kennel. At least one of the first side, the second side and the top side includes a storage area.

Another aspect of the present invention provides a kennel improvement system, comprising cover for a kennel a padded surface. The cover includes a first side configured to cover at least a part of a first side of the kennel, a second side configured to cover at least a part of a second side of the kennel, and a top side connecting the first side and the second side and configured to cover a top part of the kennel, at least one of the first side, the second side and the top side including a storage area. The padded surface is configured to be inserted into the kennel.

The present invention provides an attractive home décor friendly cover with improved usage.

### BRIEF DESCRIPTION OF THE DRAWINGS

FIG. 1 is a perspective view of an animal kennel cover according to an embodiment of the present invention;

FIG. 2 is a perspective view of the animal kennel cover of FIG. 1 with the storage area in an open state;

FIG. 3 is a partial front sectional view of the animal kennel cover of FIG. 2 illustrating the depth of the storage area;

FIG. 4 is a perspective view of the animal kennel cover of FIG. 1 with the flaps covering the kennel openings;

FIG. 5 is a perspective view of the animal kennel cover of FIG. 1 removed from the kennel;

FIG. 6 a perspective view of an animal kennel cover according to another embodiment of the present invention;

FIG. 7 is a perspective view of the animal kennel cover of FIG. 6 with the flaps attached to attachment devices on the top storage area;

FIG. 8 is a perspective view of an animal kennel cover according to another embodiment of the present invention;

FIG. 9 is a partially exploded view of FIG. 8 illustrating the tubular frame for the top storage area;

FIG. 10 is a perspective view of the animal kennel cover of FIG. 1 removed from the kennel;

FIG. 11 is a perspective view of an animal kennel cover according to another embodiment of the present invention;

FIG. 12 is a partial front sectional view of the animal kennel cover of FIG. 11 illustrating the height of the storage area and the positioning of the rolled down opening cover;

FIG. 13 is perspective view of an animal kennel cover of FIG. 11 illustrating the storage bins being removed;

FIG. 14 a perspective view of an animal kennel cover according to another embodiment of the present invention;

FIG. 15 is a partial front sectional view of the animal kennel cover of FIG. 14 illustrating the storage areas;

FIG. 16 is perspective view of an animal kennel cover of FIG. 14 illustrating the front door being stowed in a storage area;

FIG. 17 is a perspective view of an animal kennel cover according to another embodiment of the present invention;

FIGS. 18A and 18B are enlarged partial views of the animal kennel cover of FIG. 17 illustrating the cover being connected to the kennel connectors;

FIG. 19 is perspective view of an animal kennel cover of FIG. 17 with the flaps covering the kennel openings;

FIG. 20 is a perspective view of an animal kennel cover according to another embodiment of the present invention illustrating the internal bedding being inserted into the kennel;

FIG. 21 is a perspective view of an embodiment of the internal bedding;

FIG. 22 is a side view in section of the internal bedding of FIG. 21;

FIG. 23 is a partial perspective view of the internal bedding of FIG. 21 illustrating the removability of a feeding bowl;

FIG. 24 is a perspective view of another embodiment of the internal bedding;

FIG. 25 is a side view in section of the internal bedding of FIG. 24;

FIG. 26 is an enlarged partial view of the hooks to couple the internal bedding of FIG. 24 to the kennel;

FIG. 27 is a perspective view of another embodiment of the internal bedding;

FIG. 28 is a perspective view illustrating the assembly of the internal bedding of FIG. 27;

FIG. 29 is a perspective view illustrating the internal bedding of FIG. 27 in a folded state;

FIG. 30 is a perspective view of another embodiment of the internal bedding;

FIG. 31 is a perspective view of another embodiment of the internal bedding;

FIG. 32 is a perspective bottom view of the internal bedding of FIG. 31;

FIG. 33 is a side view in section of the internal bedding of FIG. 31;

FIG. 34 is a perspective view of another embodiment of the internal bedding;

FIG. 35 is a perspective view of another embodiment of the animal kennel cover; and

FIG. 36 is a perspective view of another embodiment of the animal kennel cover.

### DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

The Figures show several embodiments of the present invention. The present invention is generally directed to a cover that improves the aesthetics and usefulness or a pet kennel or carrier. The cover can be an external cover that covers the exterior walls of the kennel and/or can include a bedding portion that provides a softer cushion for an animal to lay or sleep on.

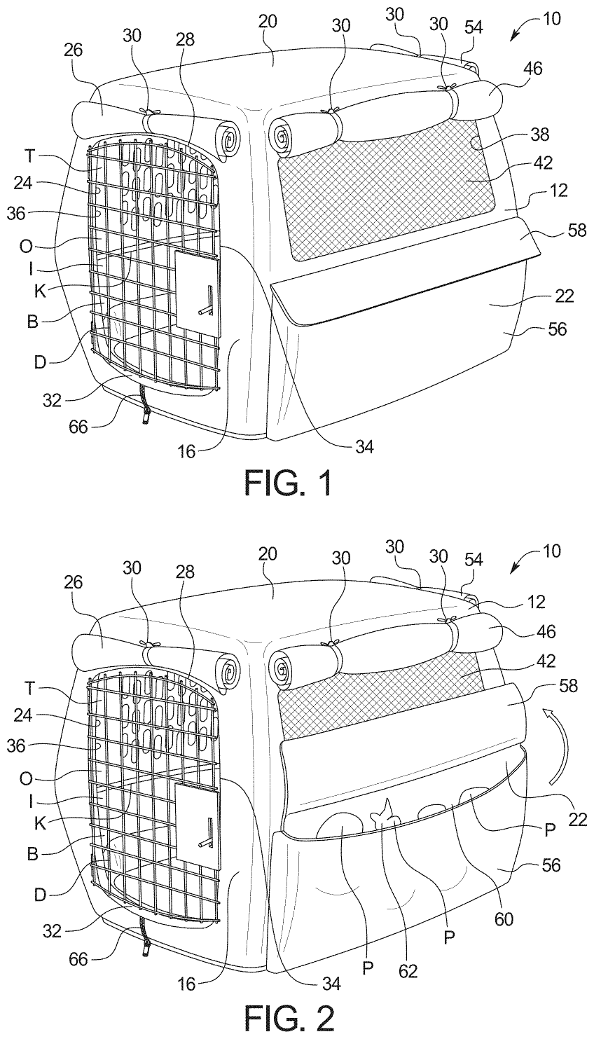

Referring initially to FIGS. 1-5, a cover 10 for a kennel K is illustrated in accordance with a first embodiment. The cover 10 can include a first (left) side 12, a second (right) side 14, a front side 16, a rear side 18 and a top side 20. The first side 12 is configured to cover at least a part of a first side of the kennel K. The second side 14 is configured to cover at least a part of a second side of the kennel K. The front side 16 is configured to cover at least part of the front side of the kennel K. The rear side 18 is configured to cover at least a part of a rear side of the kennel k. The top side 20 connects the first side 12, second side 14, the rear side 18 and the front side 16 and is configured to cover a top part of the kennel K. At least one of the first side 12, the second side 14, the front side 16, the rear side 18 and the top side 20 includes a storage area 22.

The kennel K generally has at least one opening O in the front side that enables access to an interior portion I of the kennel K. The opening O is sized and configured to enable an animal to pass through the front side an into the interior portion I of the kennel K. As can be understood, the opening O in the kennel K can have a closable and/or removable door D as discussed in more detail below. It is further noted that while, in this embodiment, the opening O in the kennel K is illustrated in the front part of the kennel K, the opening O can be in any portion of the kennel K and the opening O in the kennel K is merely described as being in the front part for ease of description. Furthermore, the kennel K can have one, two or more openings as desired in any part or parts of the kennel K.

As illustrated in FIG. 1, the cover 10 can be removable and made from a material so that the cover 10 is easy to machine wash. For example, the cover 10 can be made from fabric, leather or cotton or any desired material that enables general conformance with the exterior shape of the kennel K.

The cover 10 includes an opening 24 in the front side 16 that is generally sized and configured to have approximately the same dimensions as the opening O in the kennel K. That is, the opening 24 in the front side of the cover 10 can be the same size as the opening O in the kennel K or slightly smaller or larger but generally enables an animal to pass through the opening 24 in the cover 10 through the opening O in the kennel K and into the interior portion I of the kennel K. It is noted that while the opening 24 in the cover 10 is illustrated to correspond to the opening O in the front part of the kennel K, the opening 24 can be in any portion of the cover in an attempt to coincide with an opening in the kennel K and the opening 24 the cover 10 is merely described as being in the front part 16 for ease of description. Furthermore, the cover 10 can have one, two or more openings as desired in any part or parts of the cover to correspond to one, some or all of the openings in the kennel K.

The front side 16 can include an opening flap 26. The flap 26 is preferably attached to the front side 16 of the cover 10 at a top edge 28 of the opening 24 and is free from the other three sides of the opening 24. This configuration enables the flap 26 to be rolled upwardly to expose the opening 24 in the front side 16 of the cover 10. That is, the front side 16 can include a flap 26 that can be moved from a opened position (FIGS. 1 and 2), in which the opening 24 in the front side 16 is exposed to a closed position (FIG. 4), in which the opening 24 in the front side 16 is closed or covered. As shown in Figures, the flap 26 can be rolled upwardly and tied off with a securing system 30 (e.g., a tie) to enable the flap 26 to maintain the opened position. It is noted that the flap 26 can maintain the open position in any manner desired.

Furthermore, the flap 26 can be attached to the any of the sides 34, 36 or edges of the opening 24 desired. For example, the flap 26 can be attached to the bottom edge 32 or the side edges 34, 36 or a plurality of the edges. Portions of the flap 26 can also be removably attached. That is, in this example, the flap 26 can be permanently fixed or attached at the top edge 28, and the remainder of the flap edges can be attached to the front side 16 of the cover 10 with a zipper, a hook and loop attachment (VELCRO), snaps, buttons or in an suitable manner. See for example, FIG. 9. Moreover, any number of the edges of the flap 26 can be removable including all of the edges, including the top edge 28.

Each of the first and second sides 12, 14 of the cover 10 can have an opening 38, 40 therein. See for example FIG. 1 illustrates the opening 38 in the first side 12 and FIG. 5 illustrates the opening 40 in the second side 14. In this embodiment, the openings 38, 40 can have a mesh material 42, 44 that covers a respective opening 38, 40. As can be understood, the opening 38 in the first side 12 generally corresponds to an opening or a plurality of openings in the side of the kennel K that enables a more open feel when an animal is disposed in the interior portion I of the kennel K.

Similarly to the flap 26 in the front side 16 of the cover 10, the flaps 46, 48 in the first and second sides 12, 14 of the cover 10 have a configuration that enables the flaps 46, 48 to be rolled upwardly or downwardly to expose the openings 38, 40 in the first or second sides 12, 14 of the cover 10. That is, the first or second sides 12, 14 can include flaps 46, 48 that can be moved from a opened position (FIGS. 1 and 2), in which the openings 38, 40 in the first or second side 12, 14 is exposed to a closed position (FIG. 4), in which the openings 38, 40 in the first or second side 12, 14 is closed or covered. As shown in Figures, the flaps 46, 48 can be rolled upwardly and tied off with a tie 30 to enable the flaps 46, 48 to maintain the opened position. It is noted that the flaps 46, 48 can maintain the open position in any desired.

Furthermore, the flaps 46, 48 can be attached to the any of the sides or edges of the openings 38, 40 in any manner desired. For example, the flaps 46, 48 can be attached to the bottom edge or the side edges or a plurality of the edges. The flaps 46, 48 can also be partially removably attached. That is, in this example, the flaps 46, 48 can be permanently fixed or attached at the top edge, and the remainder of the flaps 46, 48 edges can be attached to a respective side of the cover 10 with a zipper, a hook and loop attachment (VELCRO), snaps, buttons or in an suitable manner. Moreover, any number of the edges of the flaps 46, 48 can be removable including all of the edges.

The rear side 18 of the cover can have an opening 50 therein. See for example FIG. 5 illustrating an opening 50 in the rear side 50. In this embodiment, the opening 50 can have a mesh material 52 that covers the opening 50. As can be understood, the opening 50 in the rear side 18 generally corresponds to an opening or a plurality of openings in the rear side of the kennel K that enables a more open fell when an animal is disposed in the interior portion of the kennel.

Similarly to the flap 26 in the front side 16 of the cover 10, a flap 30 in the rear side 18 of the cover 10 has a configuration that enables the flap 30 to be rolled upwardly to expose the opening 50 in the rear side 18 of the cover 10. That is, the rear side 18 can include a flap 30 that can be moved from a opened position, in which the opening 50 in the rear side 18 is exposed to a closed, in which the opening 50 in the rear side 18 is closed or covered. As can be understood, the flap 30 can be rolled upwardly and tied off with a tie 30 to enable the flap 30 to maintain the opened position. It is noted that the flap 30 can maintain the open position in any desired.

Furthermore, the flap 30 can be attached to the any of the sides or edges of the opening desired. For example, the flap 30 can be attached to the bottom edge or the side edges or a plurality of the edges. The flap 30 can also be partially removably attached. That is, in this example, the flap 30 can be permanently fixed or attached at the top edge, and the remainder of the flap edges can be attached to the front side of the cover with a zipper, a hook and loop attachment (VELCRO), snaps, buttons or in an suitable manner. Moreover, any number of the edges of the flap can be removable including all of the edges.

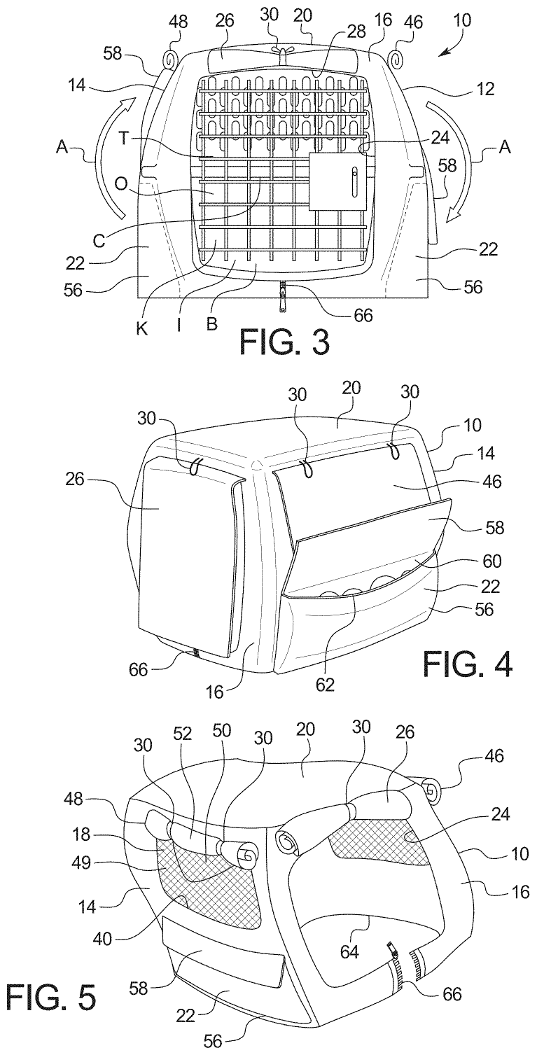

The storage area 22 can be fabric (or other suitable material) and can be disposed on the first side 12 of cover 10. In this embodiment, the storage area 22 can be a pocket 56 with expandable sides and a cover or flap 58. The pocket 56 extends about the length of the first side 12 of the cover and has a height that is about the same as the height of the connection C between the top portion T of the kennel K and the bottom portion B of the kennel K. Thus, as shown in FIG. 3, the pocket 56 can have increased volume or room from top to bottom, since the bottom portion B of the kennel K generally reduces in width from the top of the bottom portion B to the bottom of the bottom portion B. Further, the pocket cover 58 can be disposed in a closed position (see FIG. 1 and the first side 12 of FIG. 3), covering the opening of the pocket to an open position (see FIG. 2 and the second side 14 of FIG. 3) exposing the opening in the pocket. Additionally, see the arrows A in FIG. 3, illustrating the opening and closing of the pocket cover 58. As can be understood, the opening 60 in the storage area 22 is preferably disposed along the top portion 62 of the pocket 56 to enable items P to be disposed and stored therein. Of course, the items P can be any suitable items, but the storage area 22 is generally intended to store pet items, such as toys, a leash, treats, or any other item desired.

The pocket cover 58 can be maintained in the closed and/or open position in any manner desired. That is, the closed position can be maintained using hook and look fasteners (VELCRO), a button, zippers, a tie, or any other fastener, or there can be no fastener. The open position can be similarly maintained using hook and look fasteners (VELCRO), a button, zippers, a tie, or any other fastener, or there can be no fastener.

As shown in FIG. 5, the cover can be opened at the bottom 64 and include a front zipper connection 66 to enable the cover 10 to securely fit over the kennel K. Preferably the zipper connection 66 is below the opening 24 in the cover 10 (i.e., at the front bottom of the cover 10) and enables this portion of the cover 10 to be separated, enabling easy removable and installation of the cover 10 onto and off of the kennel K. The connection 66 does not necessarily need to be at the front side as illustrated and can be on any portion of the cover 10. Further, the connection 66 does not need to be a zipper and can be any suitable connection, such ask hook and look fasteners (VELCRO), a button, a tie, or any other fastener.

In one embodiment, the bottom edge 64 of the cover 10 is not separable as illustrated in FIG. 5. Rather, the cover has an elastic (or drawstring) bottom edge that allows the bottom edge to be expanded and then contracted around the bottom portion of the cover 10 to ensure a secure fitting over the kennel K. In another embodiment, the cover 10 can simply hang over the kennel K and does not need a secure fitting at the bottom edge 64.

In one embodiment, portions of the cover 10 can be wrapped on the underside of the kennel K, therefore insulating the kennel K from the flooring. In this embodiment, the cover 10 can protect the kennel K from scratching flooring if a pet scoots the kennel K around while being housed. Non slip fabric can be disposed on the bottom of the cover 10 to prevent movement of the kennel K.

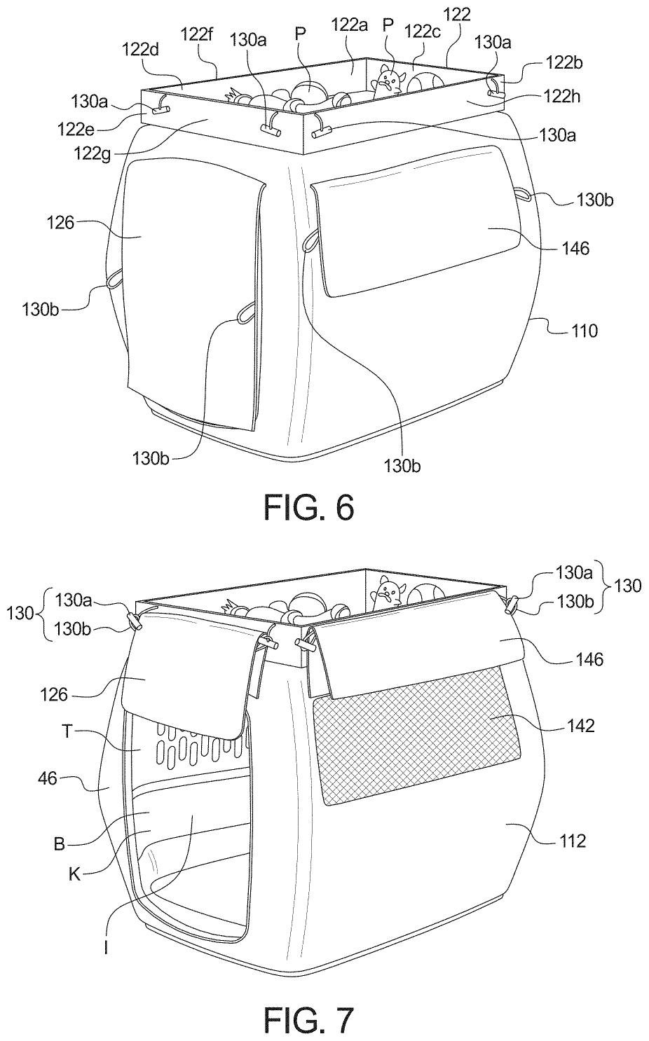

FIGS. 6 and 7 illustrate another embodiment of a cover 110 of the present invention, in which the storage area 122 is disposed on the top side 120 of the cover 110. In this embodiment, the storage area 122 generally has the same outer dimensions as the top side of the kennel K to maximize the interior area 122a of the storage area 122. In this embodiment, the storage area 122 is essentially a box with four walls 122b-122e and an opened top 122f The four walls 122b-122e enable items P to be disposed and stored therein and the opened top 122f enables easy access to the interior area 122a of the box. Of course, the items P can be any suitable items, but the storage area 122 is generally intended to store pet items, such as toys, a leash, treats, or any other item desired.

The flaps 126, 146 of the cover 110 can be attached to the outer surfaces 122g, 122h of the walls of the box to enable the flaps 126, 146 to be disposed in the open position. As discussed above, the flaps 126, 146 can be maintained in the closed and/or open position in any manner desired. In this embodiment, the cover 110 can include a securing system 130 (e.g., cord loops) to secure the flaps 126, 146 in an up or down position. In an up position the flaps 126, 146 can expose mesh privacy screening 142. In a down position, the flaps can cover the mesh privacy screening 142 and provide a fully covered kennel K.

Further, as can be understood, the closed position can be maintained using hook and look fasteners (VELCRO), a button, zippers, a tie, or any other fastener, or there can be no fastener. The open position can be similarly maintained using hook and look fasteners (VELCRO), a button, zippers, a tie, or any other fastener, or there can be no fastener. As illustrated in FIGS. 6 and 7, the outer surfaces (e.g., 122g, 122h) of the walls of the storage area 122 have toggles 130a and the flaps 126, 146 have loops 132b that are configured to attach to the toggles 130a to form a securing system 130 that is capable of maintaining the flaps 126, 146 in the opened position. As can be understood, only the flap 126 of the front side 116 of the cover 110 and the cover 146 of the first side 112 are illustrated, but it can be understood, that the cover 110 can have flaps on the second side and the rear side in a manner similar to the cover 10 described above.

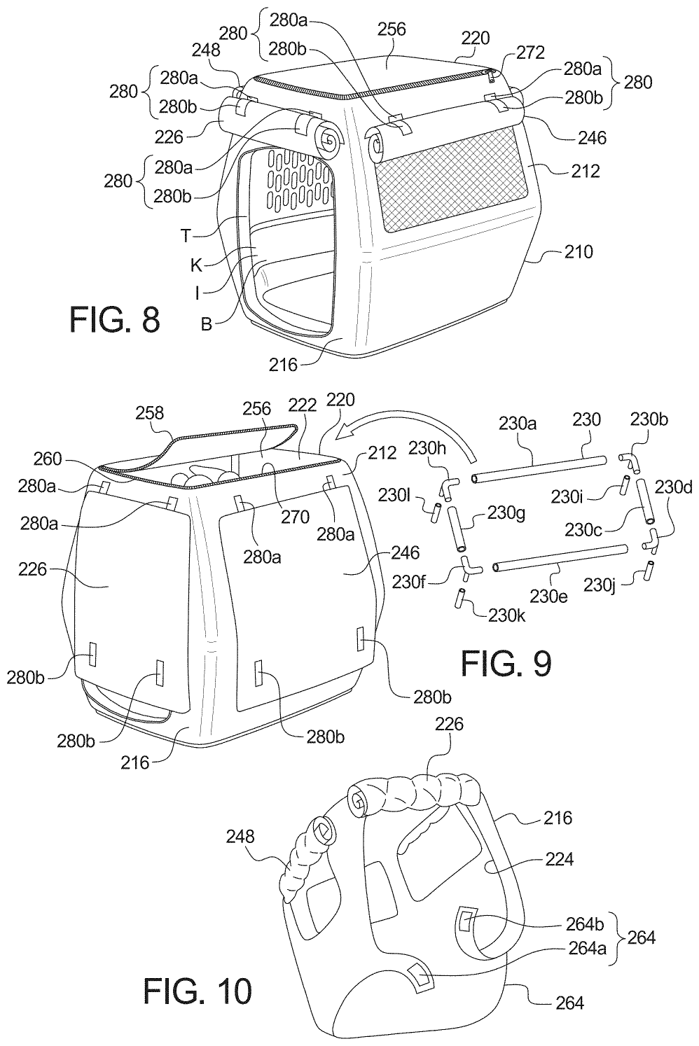

FIGS. 8-10 illustrate another embodiment of a cover 210 of the present invention. Similarly, to the embodiment above, in this embodiment the storage area 222 is disposed on the top portion 220 of the cover 210. In this embodiment, the storage area 22 is disposed within the cover 210 and is formed by a tubular structure 230. That is, the top portion 220 of the cover 210 can have pocket 256 with a bottom surface, four walls and a top cover of flap 258. A tubular structure 230 can be inserted into the pocket 256 to provide structural rigidity to the pocket 256. The tubular structure 230 can be removable and can include a plurality of tubular members 230a-230l that can be connected together. That is, tubular members 230a-230h can be connected to form a rectangular outer perimeter structure and the tubular members 230i-230l can be connected to tubular member 230b, 230d, 230f and 230h, respectively to provide structural integrity to the height of the pocket 256. In one embodiment, the top portion 220 of the cover 210 has an overlapping edge 270 surrounding the opening 260 in the cover 210 that enables the tubular structure 230 to be inserted thereunder and maintain the tubular structure 230 in within the pocket 256. Alternatively, the tubular structure 230 can be integral or sewn into the pocket 256 and hidden from view.

In this embodiment, the storage area 22 can include a top cover 258 that can be removed or partially removed to enable access into the storage area 22. As illustrated in FIG. 8, the top cover 258 can be connected to the cover with a zipper 272. The zipper 272 can extend along three sides of the opening 260 to enable the top cover 285 to remain attached to the cover 210. However, it is noted that the zipper 272 can enable attachment to as many or as few of the sides as desired.

The flaps 226, 246, 248 in the cover 210 that expose the openings in the kennel K can be maintained in the open position in any manner desired. As illustrated in FIG. 8, in this embodiment, the flaps are illustrated as being maintained in the opened position using a securing system 280 that is a hook and look fasteners (VELCRO). The hook and loop fasteners can include a first portion 280a (e.g., either the hook or loop portion) can be disposed on the front portion 16 and the first side 16 and a second portion 280b (e.g., the other of the hook or loop portion) at the bottom corners of the flaps 226, 246 to form the securing system 280. Thus, when rolled in the open position the hook and loop fasteners can hold the entire flap 226, 246 up and out of the way, and in the closed position, the hook and loop fasteners can maintain the entire flap 226, 246 in a closed position. As can be understood, only the flap 226 of the front side 216, flap 248 of the cover 110 and the flap 246 of the first side 212 are illustrated, but it can be understood, that the cover 210 can have flaps on the rear side in a manner similar to the cover 10 described above.

Further as described above, the cover 210 can be opened at the bottom 264 and include a connector 266 front hook and look fastener (VELCRO) connection to enable the cover to securely fit over the kennel. As with the securing system 280, the connector 266 can include a first portion 266a (e.g., either the hook or loop portion) and a second portion 266b (e.g., the other of the hook or loop portion) to form the securing system 266. Preferably the hook and look fastener connection is below the opening 224 in the cover 210 (i.e., at the front bottom of the cover 210) and enables this portion of the cover 210 to be separated, enabling easy removable and installation of the cover 210 onto and off of the kennel K. The connector 266 does not necessarily need to be at the front side 216 as illustrated and can be on any portion of the cover. Further, the connector 266 does not need to be a hook and look fastener and can be any suitable connection, such ask a zipper, a button, a tie, or any other fastener.

In one embodiment, the bottom edge 264 of the cover 210 is not separable as illustrated in FIG. 10. Rather, the cover 210 has an elastic (or drawstring) bottom edge that allows the bottom edge 264 to be expanded and then contracted around the bottom portion of the kennel K to ensure a secure fitting over the kennel K. In another embodiment, the cover 210 can simply hang over the kennel K and does not need a secure fitting at the bottom edge.

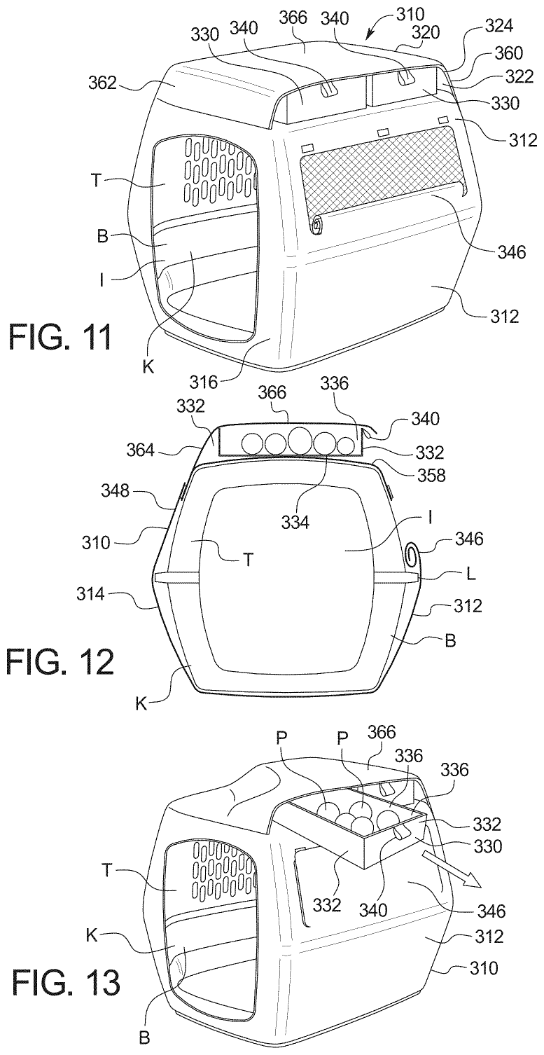

FIGS. 11-13 illustrate another embodiment of a cover 310 of the present invention. Similarly, to the embodiment above, in this embodiment the storage area 322 is disposed on the top portion 320 of the cover 310. In this embodiment, the storage area 322 is disposed within the cover 310 and has an opening 324, for example, along the first side 312 of the cover. That is, the top portion 320 of the cover 310 can have pocket 356 with a bottom surface 358, three walls 360, 362, 364 and a top cover 366. The opening 324 is disposed in one side of the top portion 320 and drawers 330 or other structures can be side into and out of the opening 324. As can be understood, the drawers 330 can have four walls 332, a bottom 334 and an opening 336 in the top for access into the interior 338 of the drawer 330. The drawer can have a pull mechanism 340, such as a tab or knob for removing the drawer 330 from the opening in the cover 310.

In this embodiment, the flaps 346, 38 can roll in a downward direction and store in the lip L of the kennel K. See, for example, FIG. 12. As can be understood, the lip L of the kennel K is the connection area between the top portion T of the kennel K and the bottom portion B of the kennel K. As can be understood, only the flap 326 of the first side 112 is illustrated, but it can be understood, that the cover 310 can have flaps on the second side, the front side and the rear side in a manner similar to the cover 10 described above.

Further, in this embodiment, as shown in FIG. 12, the cover 310 extends completely around the kennel K. As discussed above, such a configuration can protect the floor on which the kennel K sits from marking or scarring if the kennel K is moved or slid along the floor.

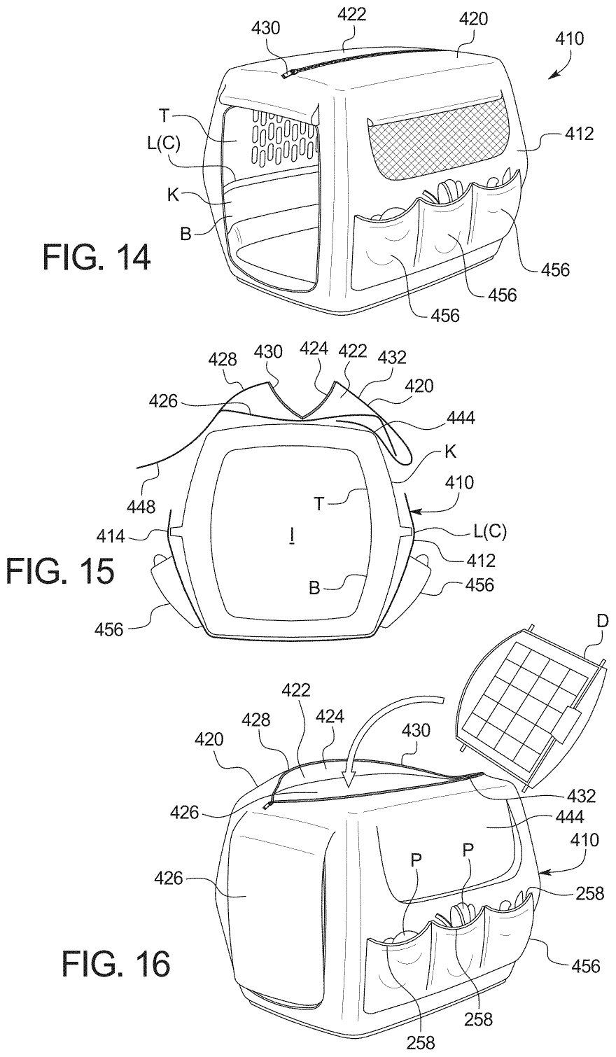

FIGS. 14-16 illustrate another embodiment of a cover 410 according to the present invention. This embodiment, the cover 410 includes a top storage area 422. The top storage area 422 is sized and configured to hold a the door D. That is, in this embodiment, the door D to the kennel K can be removable. Many users opt to remove the door D to enable easy access for the animal into and out of the kennel K. This can be done, for example, to encourage the animal to use the kennel K as a safe space or a sleeping area. The door D can then be replaced in the instances where the user desires to prevent the animal from the leaving the kennel K. When the door D is removed, the door D can be stored in the storage area 422 on top portion 420 of the cover.

The top portion 420 of the cover 410 can include an opening 424 into the storage area 422 (i.e., pocket) with a closing or securing mechanism 430 closing. The storage area 422 is defined by a bottom surface 426 and two flaps 428, 432. In this embodiment, the storage area 422 is relatively thin and sized an configured to hold a relatively flat, rectangular door D member therein.

As discussed above, in this embodiment, the opening 424 defined by the flaps 428, 432 is maintained in a closed position with the closing or securing mechanism 430 (i.e., a zipper). However, it is noted that the closing mechanism 424 can be a hook and loop attachment (VELCRO), snaps, buttons or in an suitable closing mechanism.

The flaps 426, 446, 448 that are configured to cover the openings in the kennel K can be folded or rolled inwardly and upwardly and tucked between the bottom surface 426 of the storage area 422 and the top of the kennel K. See for example, FIG. 15. Thus, the friction between the cover 410 and the kennel K can maintain the flaps 426, 446, 448 in an opened position. As can be understood, only the flaps 426, 446, 448 are illustrated, but it can be understood, that the cover 410 can have flaps on the second side and the rear side in a manner similar to the cover 10 described above.

Further, in this embodiment, as shown in FIG. 15, the cover 410 extends completely around the kennel K. As discussed above, such a configuration can protect the floor on which the kennel K sits from marking or scarring if the kennel K is moved or slid along the floor.

In this embodiment, the cover 410 can also include a plurality of storage areas 456 disposed on the first side 412 of the cover 410 and the second side 414 of the cover 410, as shown in FIGS. 14 and 15. The plurality of storage areas 456 can be a pockets with expandable sides. The storage areas 456 extend about the length of the first side 412 and the second side 414 of the cover 410 and have a height that is about the same as the height of the connection C of the lip L between the top portion T of the kennel K and the bottom portion B of the kennel K. As can be understood, the openings 258 in the storage areas 456 are preferably disposed along the top portion of the storage areas 456 to enable items P to be disposed and stored therein. Of course, the items P can be any suitable items, but the storage areas 456 are generally intended to store pet items, such as toys, a leash, treats, or any other item desired.

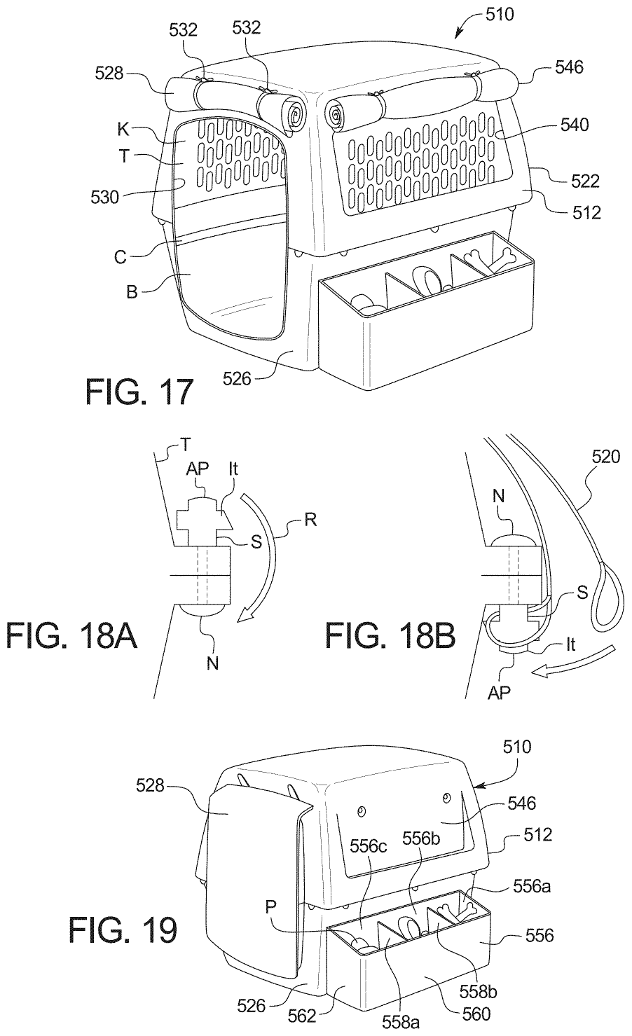

FIGS. 17-19 illustrate another embodiment of a cover 510 according to the present invention. In this embodiment, the cover 410 includes loops 520 to secure a top portion 522 of the cover 510 the anchor points AP between the top T of the kennel K and the bottom B of the kennel K, as shown in FIGS. 18A and 18B. As can be understood, the kennel nuts N can be inverted to position the head H of the nut N to be in an inverted position, as illustrated by the arrow R in FIG. 18A. In this position since the head H of the nut N has a larger diameter than the shaft S, the loop 520 can be securely positioned around the nut N and hold the cover 510 onto the kennel K.

Similarly to embodiments described above, the front side 526 of the cover 510 can include an flap 528. The flap 528 is preferably attached to the front side 526 of the cover 510 at a top edge of the opening 530 and is free from the other three sides of the opening 530. This configuration enables the flap 528 to be rolled upwardly to expose the opening 530 in the front side 526 of the cover 510. That is, the front side 526 can include a flap 528 that can be moved from a opened position (FIG. 17), in which the opening 530 in the front side 526 is exposed to a closed position (FIG. 19), in which the opening 530 in the front side 526 is closed or covered. As shown in Figures, the flap 528 can be rolled upwardly and tied off with a tie 532 or a plurality of ties to enable the flap 528 to maintain the opened position. It is noted that the flap 528 can maintain the open position in any desired.

Furthermore, the flap 528 can be attached to the any of the sides or edges of the opening 530 desired. For example, the flap 528 can be attached to the bottom edge or the side edges or a plurality of the edges. The flap 528 can also be removably attached. That is, in this example, the flap 528 can be permanently fixed or attached at the top edge, and the remainder of the flap edges can be attached to the front side of the cover with a zipper, a hook and loop attachment (VELCRO), snaps, buttons or in an suitable manner. Moreover, any number of the edges of the flap can be removable including all of the edges.

Each of the first and second sides of the cover 510 can have an opening therein. See for example FIG. 17 illustrating an opening 540 in the first side 512. In this embodiment, the opening 540 can have a mesh material (not shown) that covers the opening 540. As can be understood, the opening 540 in the first side 512 generally corresponds to an opening or a plurality of openings in the side of the kennel K that enable a more open feel when an animal is disposed in the interior portion I of the kennel K.

Similarly to the flap 528 in the front side 526 of the cover 510, the flap 546 in the first side 512 and the flap in the second side of the cover 510 have a configuration that enables the flaps to be rolled upwardly to expose the opening in the first or second side of the cover. That is, the first or second side can include a flap that can be moved from a opened position (FIG. 17), in which the opening in the first or second side is exposed to a closed position (FIG. 19), in which the opening in the first or second side is closed or covered. As shown in Figures, the flaps in the first and second sides can be rolled upwardly and tied off with ties to enable the flap to maintain the opened position. It is noted that the flap can maintain the open position in any desired.

Furthermore, the flaps in the first and second sides can be attached to the any of the sides or edges of the opening desired. For example, the flaps in the first and second sides can be attached to the bottom edge or the side edges or a plurality of the edges. The flap can also be removably attached. That is, in this example, the flaps in the first and second sides can be permanently fixed or attached at the top edge, and the remainder of the flaps in the first and second sides edges can be attached to the front side of the cover with a zipper, a hook and loop attachment (VELCRO), snaps, buttons or in an suitable manner. Moreover, any number of the edges of the flap can be removable including all of the edges. As can be understood, only the flaps 528, 546 are illustrated, but it can be understood, that the cover 510 can have flaps on the second side and the rear side in a manner similar to the cover 10 described above.

As illustrated in FIGS. 17 and 19, the cover can also include a storage area 556 that includes plurality of bins 556a, 556b, 556c on the first side 512. The storage area 556 can be a pockets with rigid or semi-rigid sides 560, 562. The storage area 556 extends about the length of the first side 512 of the cover 510 and has a height that is about the same as the height of the connection C between the top portion T of the kennel K and the bottom portion B of the kennel K. As can be understood, the openings in the bins 556a, 556b, 556c are preferably disposed along the top portion of the bins 556a, 556b, 556c to enable items P to be disposed and stored therein. Of course, the items P can be any suitable items, but the pocket is generally intended to store pet items, such as toys, a leash, treats, or any other item desired.

Further, each of the bins is separated by an interior wall 558a, 558b. In some embodiments, the interior walls 558a, 558b can be removable and/or movable. Thus, the bins 556a, 556b, 556c are configurable to have any number of various sizes or numbers. In other words, the interior walls 558a, 558b can be moved to change the size of each individual bin 556a, 556b, 556c, or one, some or all of the interior walls 558a, 558b can be removed to create one large bin, or a plurality of smaller bins. The interior walls 558a, 558b can be connected to the interior of the bin in any suitable manner, such as hook and loop (Velcro).

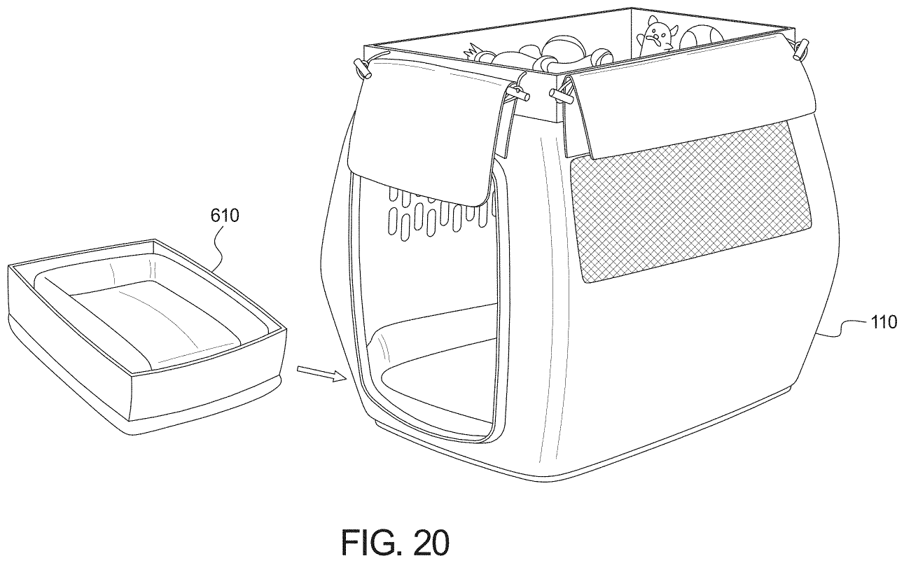

As illustrated in FIG. 20, the cover (e.g., 110) can be one aspect of a kennel improvement system that further includes a removable padded surface 610 (e.g., bedding). Thus, as can be understood, the bedding 610 can be formed from a comfortable material that improves the animals enjoyment of the use of the kennel K.

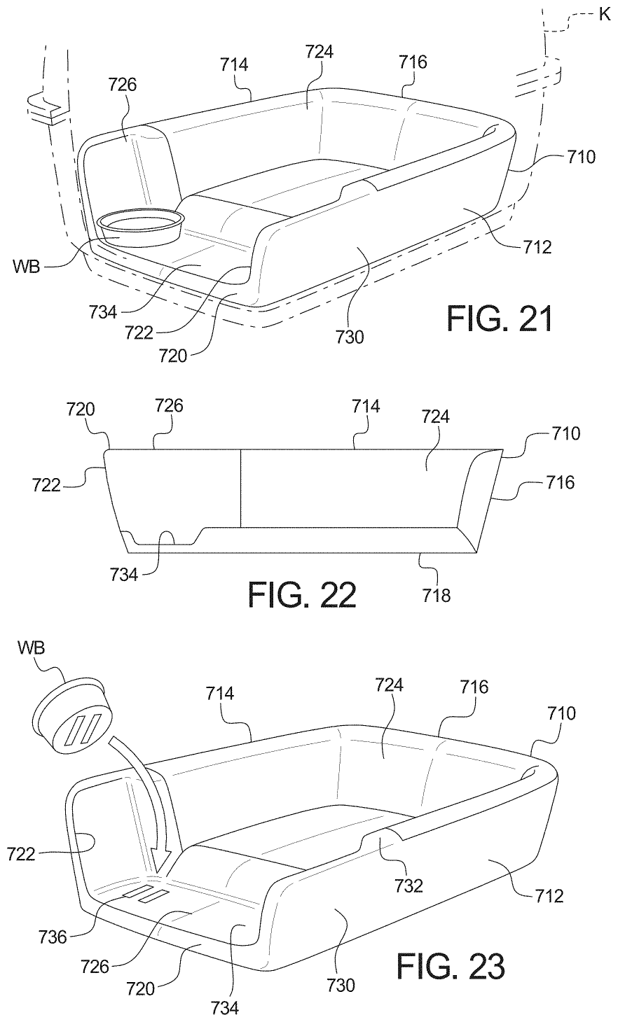

As shown in FIGS. 21-23 illustrate one embodiment of the bedding 710 according to the present invention. In this embodiment, bedding 710 has a first wall 712, a second wall 714, a rear wall 716 disposed between the first wall 712 and the second wall 714 and bottom 718. At a front area 720, the bedding 710 has no wall or an opening 722 that enables easy access to the bedding 710. The bedding 710 further has a first or rear portion 724 and a second or front portion 726. The first portion 724 can be formed from fluffy material and/or a padding for the animal to lie on. This padding can be a comfortable material that improves the use of the bedding 710. The second portion 726 of the bedding 710 can be made from a waterproof material to protect the bedding 710 from spilled food or water. The waterproof material can be any suitable plastic or rubber material or any other type of material. Moreover, the same or a similar waterproof material can be disposed on the exterior 730 of the bedding 710, as illustrated in FIG. 23, which specifically shows the material in the second portion 724 wrapping to the exterior of the bedding 710 at 732. Such a material can reduce the wear and tear on the bedding 710 and thus prolong the usable life thereof.

As illustrated in FIGS. 21-23, the bedding 710 can have a recessed portion 734 that is configured to receive a feeding and/or water bowl WB. As noted above, recessed portion 734 can comprise about one fourth of the overall length of the bedding 710 and is disposed in the second portion 726 of the bedding at the opening 722. However, it is noted that the recessed portion 734 can be any size desired and be disposed in any position desired. The recessed portion 734 can include a securing mechanism 736 that comprises a hook and loop (or any other suitable device or attachment system) system that enables a bowl WB to be securely attached. The first portion 724 can include any type of suitable padding for the animal.

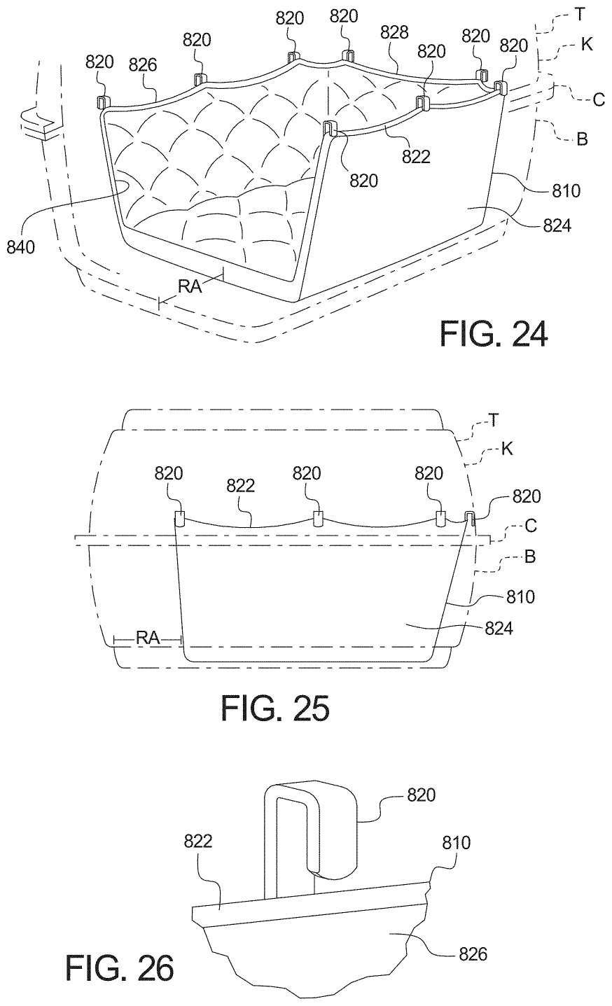

As shown in FIGS. 24-26, in one embodiment, the bedding 810 can include tabs 820 that are sewn into the top perimeter 822 of the first, second and rear sides of bedding 824, 826, 828. The tabs 820 can be plastic U-shaped hooks that are inserted into the vent holes of the kennel K and can hold up or suspend the bedding 810 in the kennel K. The bedding 810 can include fabric sides, a cushioned bottom and the front area or side of the bedding can have an opening 840 to enable the animal to enter and exit the kennel and to enable spillage to exit the bedding 810.

The bedding 810 can have a length that is less than the length of the kennel K. Thus, when properly positioned within the kennel K, the bedding 810 exposes a bottom of the kennel K, as specifically shown in FIGS. 24 and 25. Thus, similarly to the embodiment described above, the bedding 810 forms a recessed area RA that is configured to receive a feeding and/or water bowl. As noted above, recessed area RA can comprise about one fourth of the overall length of the kennel K and is disposed in front of the bedding 810 at the opening 840. However, it is noted that the recessed area can be any size desired and be disposed in any position desired.

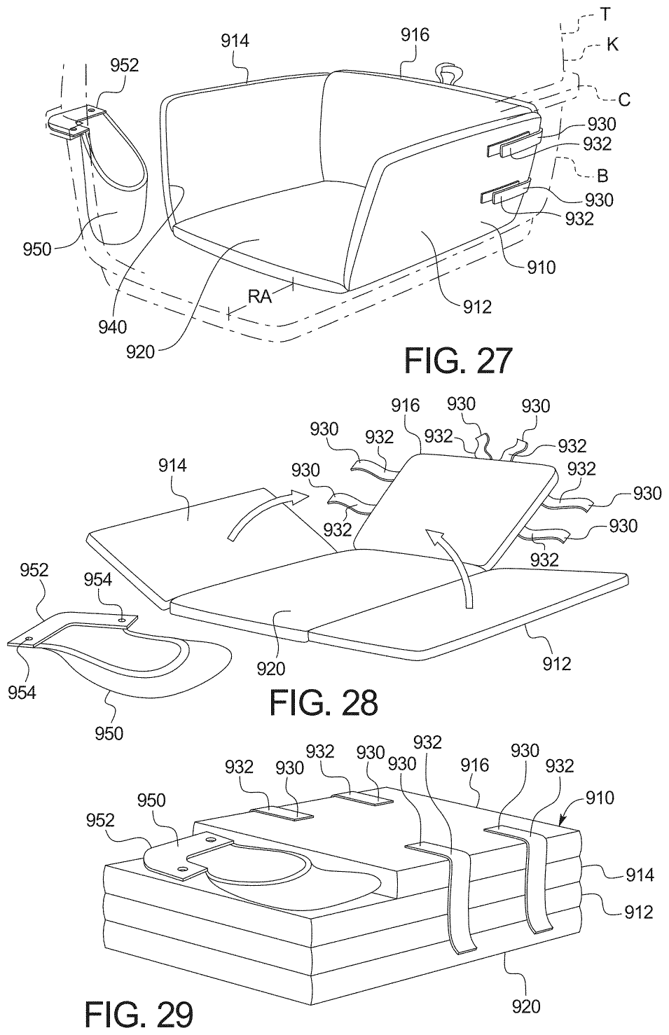

As shown in FIGS. 27-29, another embodiment of the bedding 910 can fold flat. In this embodiment the bedding 910 can include a hook and loop closure system 930 at the rear or back wall 916 to form a three walled bedding system. That is, as described above, the bedding can include a first wall 912, a second wall 914 and a rear wall 916 disposed between the first wall 912 and the second wall 914. Straps 932 on the rear wall 916 of the bedding 910 can attach to the first and second walls 912, 914 using a hook and loop fastener 930 (e.g., VELCRO). As shown in FIG. 28, the straps 932 can be detached from the first and second walls 912, 914, and the first and second walls 912, 914 can be folded so as to overlie the bottom surface 920 of the bedding 910. The rear wall 916 can then be folded over the first and second walls 912, 914 and the hook and loop fastener 930 can then be used to maintain the bedding 910 in the folded position.

The bedding can include fabric sides, a cushioned bottom and the front area or side of the bedding can have an opening 940 to enable the animal to enter and exit the bedding 910 and to enable spillage to exit the bedding 910. Further, the bedding 910 can have a length that is less than the length of the kennel K. Thus, when properly positioned within the kennel K, the bedding 910 exposes a bottom of the kennel K. Accordingly, similarly to the embodiment described above, the bedding forms a recessed area RA that is configured to receive a feeding and/or water bowl. As noted above, recessed area RA can comprise about one fourth of the overall length of the kennel K and is disposed in front of the bedding 910 at the opening 940. However, it is noted that the recessed area RA can be any size desired and be disposed in any position desired.

A water or feeding bag 950 can be attached in front of the bedding 910 on the interior wall of the kennel K. In this embodiment, the water or feeding bag 950 can include a tab 952 that can be disposed between the top and bottom portions T, B of the kennel K. Thus, when the kennel nuts N are used to secure the top and bottom portions T, B of the kennel K, the nuts N can pass through openings 954 in the tab 952, and thus securely hold the water or feeding bag 950 in position.

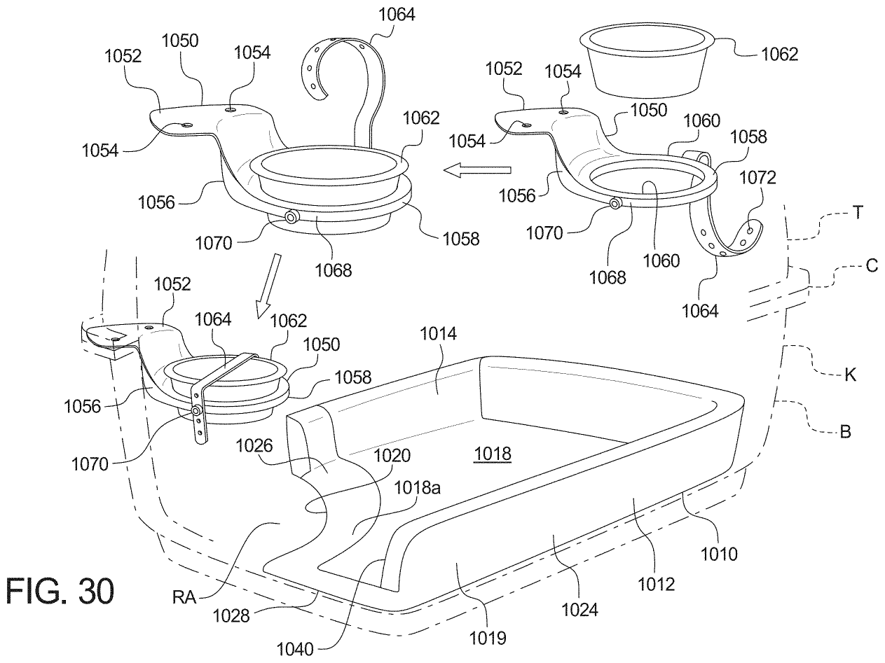

FIG. 30 illustrates another embodiment of the bedding 1010 according to the invention in which the bedding 1010 includes a recessed area RA or cutout 1020 for a bowl holder 1050. In this embodiment, the cutout 1020 in the bedding 1010 can accommodate a bowl holder 1050 or be disposed in area below an intended position of the bowl holder 1050. The cutout 1020 in this embodiment is arcuate such that is corresponds to the shape of a circular bowl holder 1050.

The bowl holder 1050 can be plastic and configured to be positioned between the top and bottom portion T, B of the kennel K in a position above the bedding 1010. As described above, the bowl holder 1050 can include a tab 1052 that can be disposed between the top and bottom portions T, B of the kennels K. Thus, when the kennel nuts N are used to secure the top and bottom portions T, B of the kennels K, the nuts N pass through openings 1054 in the tab 1052, and thus securely hold the bowl holder 1050 in position.

In this embodiment, the bowl holder 1050 includes a flange 1056 connecting the tab 1052 to the base 1058. The base 1058 can be generally circular with a circular opening 1060. The exterior of the base 1058 corresponds the general shape of a bowl 1062 and the opening 1060 is sized and configured to hold the bowl 1062. The opening 1060 can be standard opening as is understood in the art and be suitable for many types of bowls. Further, the base 1058 can include an elastic strap 1064 to lock the bowl in place, as shown in FIG. 30. The strap 1064 can be attached to the base 1058 on a first side 1066 and removably attached on second side 1068. In this embodiment the second side 1068 of the base 1058 includes a protrusion or a locking mechanism 1070. The strap 1064 includes an opening or a plurality of openings 1072, any of which can be positioned such that the protrusion 1070 is disposed within the opening 1072. This positioning locks the strap 1064 over the bowl 1062, holding the bowl 1062 in place in the opening 1060 of the base 1058. It is noted that the strap 1064 can be removably attached to both the first and second sides 1066, 1068 and connect to the sides in any manner desired. Moreover, the strap 1064 can be non-removably attached to either or both of the first and second sides 1066, 1068 and have elastic properties that enable the strap 1064 to be stretched over the bowl 1062 and securely hold the bowl 1062 in place.

The bedding 1010 can include a first or rear portion 1024 and a second or front portion 1026. The first portion 1024 can be formed from plush material and/or a padding for the animal to lie on. This plush material can be a comfortable material that improves the use of the bedding 1010. The second portion 1026 of the bedding 1010 can be made from a waterproof material to protect the bedding 1010 from spilled food or water. In this embodiment, the waterproof material is disposed along the cutout 1020 and the front edge 1028 of the bedding 1010, including the first and second walls 1012, 1014 and a portion 1018a of the bottom surface 1018 of the bedding 1010. The waterproof material can be any suitable plastic or rubber material or any other type of material. Moreover, the same or a similar waterproof material can be disposed on the exterior 1019 of the bedding 1010. Such a material can reduce the wear and tear on the bedding and thus prolong the usable life thereof.

Additionally, if desired the bedding 1010 can have small or short walls. The front area or side of the bedding 1010 can have an opening 1040 to enable the animal to enter and exit the bedding 1010 and to enable spillage to exit the bedding 1010.

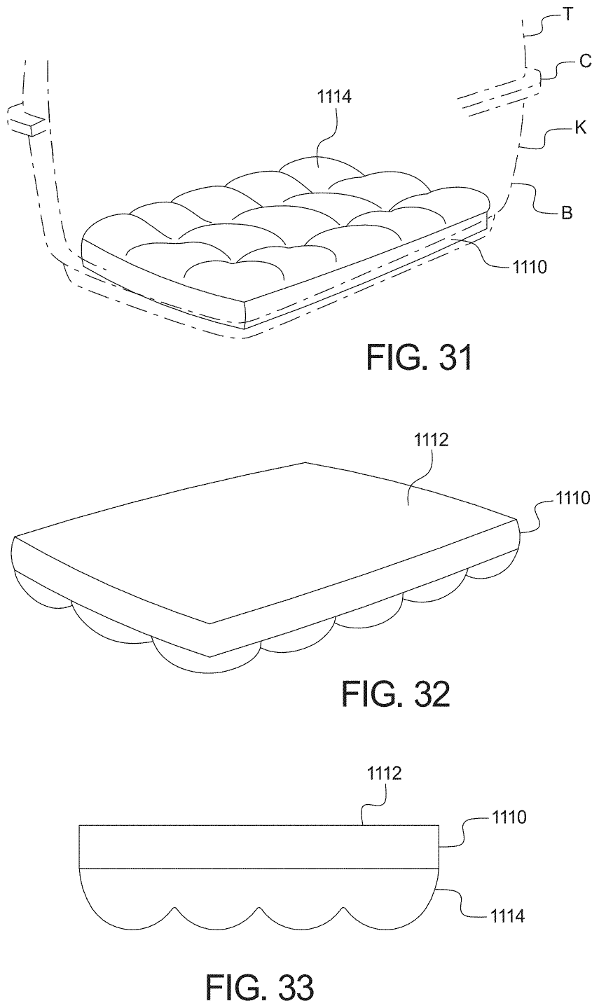

FIG. 31-33 illustrates another embodiment of the bedding 1110 of the present invention in which the bedding is two sided. One side (first side 1112) can include a firm (e.g., memory foam) side and the other side (second side 1114) can include a fluffy, poly filled side.

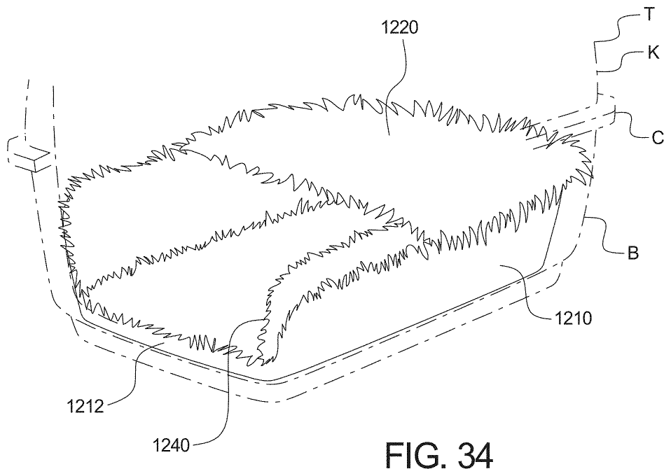

FIG. 34 illustrates another embodiment of the bedding 1210 of the present invention in which the bedding 1210 has a generally square or rectangular interior footprint and includes a shag fur interior. The front area 1212 or side of the bedding 1210 can have an opening 1240 to enable the animal to enter and exit the bedding 1210 and to enable spillage to exit the bedding 1210. Moreover, a furry or shag canopy 1220 can be adding to partially or fully cover the pet when disposed within the bedding. The canopy 1220 enables the pet to nest in the bedding 1210. The canopy 1220 can extend only partially along the length of the bedding 1210, such that the bedding 1210 is not fully enclosed. However, it is noted that the canopy 1220 can extend as far or short as desired. If desired, a waterproof material can be disposed on the exterior of the bedding 1210. Such a material can reduce the wear and tear on the bedding 1210 and thus prolong the usable life thereof.

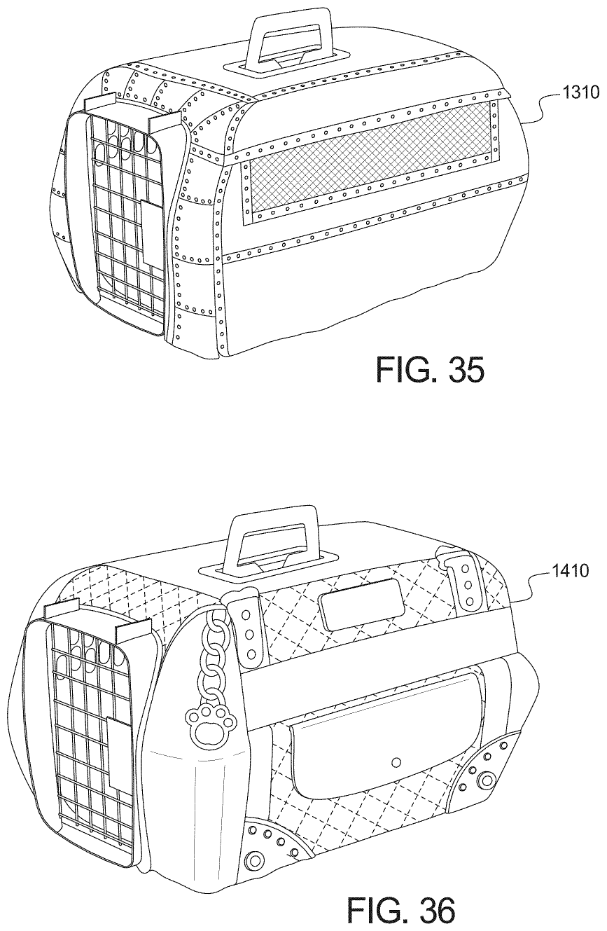

FIGS. 35 and 36 illustrate embodiments in which the covers 1310 and 1410 and decorative exteriors that the covers can display. For example, the covers 1310 and 1410 can appear as a metallic camper (FIG. 35) or a deluxe handbag (FIG. 36). It is noted that the cover appearance can be any desired appearance and the appearances in FIGS. 35 and 36 are merely exemplary.

The covers and bedding described herein can have other suitable configurations. For example, the bedding can have a pleated material over a foam construction. Such a design can resemble a loose tufted pillow or a large loose pleated pillow. The bedding can have a chunky wool weaved pattern with a horseshoe shaped footprint. In such embodiments, the front area or side of the bedding can be open to enable the animal to enter and exit the kennel K and to enable spillage to exit the kennel K.

The embodiments described herein provide a kennel K that is comfortable and inviting to the pet. By providing beds with high sides with plush and pleated fabrics, the bedding/cover allows the pet ample surfaces to scratch, dig and rearrange to suit their personal bedding taste. Additionally, the cover can mimic the home décor soft seating such as on a chair, sofa or soft throw.

In some embodiments, the cover can include fabric print that resembles home textures, such as roof shingling, siding, or any other suitable home aesthetics. The cover can include curtain style windows and door covers, and a welcome matt attached to the cover adjacent the door opening. The cover can also include a top slit or area for storage.

As can be understood, the cover can have various exterior designs. For example, the kennel can have an airstream design, a she′ shed design with a stone wall and shingled roof, a handbag/pocket book design with tweed texture and/or quilted look, a “hippie” design, a “hippie” bus design, a treat stand design (e.g., ice cream or lemonade), a kids bright colored or color blocking design, a mixed fabric/pattern design and a man cave design.

In one embodiment, since the cover or bedding is removable, they can made from a material that is easy to machine wash. Built in pockets in various locations can be used to house toys and other pet accessories. The cover can be used to soften the rattle and clanging that tend to occur when the pet is housed in the kennel.

It is noted that any aspect of the embodiments disclosed herein can be combined with any other aspect of any other embodiment and each embodiment is merely for illustrative or exemplary purposes.

The embodiments of the cover can be dual purpose. That is, one feature of the cover according to an embodiment of the present invention is to soften the look and feel of the hard plastic and wire on the plastic kennel. Another feature of the cover according to an embodiment of the present invention is to add a level of convenience for the consumer.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention.

What is claimed is:

1. A cover for a kennel, comprising:
a first side configured to cover at least a part of a first side of the kennel;
a second side configured to cover at least a part of a second side of the kennel; and
a top side connecting the first side and the second side and configured to cover a top part of the kennel,
at least one of the first side, the second side and the top side including a storage area.

2. The cover according to claim 1, wherein
the storage area is a storage bin disposed on the top side.

3. The cover according to claim 1, wherein
the storage area is a pocket disposed on the first side.

4. The cover according to claim 3, wherein
the pocket is sized and configured to occupy a draft area on a bottom portion of the kennel.

5. The cover according to claim 1, further including
a front side including an opening sized and configured to enable an animal to pass through.

6. The cover according to claim 5, further including
a movable door configured to cover the opening.

7. The cover according to claim 5, wherein
edges of the opening include elastic.

8. The cover according to claim 1, wherein
the storage area is sized and configured to accept a removable door from the kennel.

9. The cover according to claim 1, wherein
the storage area includes a tubular frame.

10. The cover according to claim 1, wherein
the storage area is sized and configured to accept storage bins.

11. The cover according to claim 1, further including
anchors configured to attach to the kennel.

12. A kennel improvement system, comprising:
a cover for a kennel including comprising a first side configured to cover at least a part of a first side of the kennel, a second side configured to cover at least a part of a second side of the kennel, and a top side connecting the first side and the second side and configured to cover a top part of the kennel, at least one of the first side, the second side and the top side including a storage area; and
a padded surface configured to be inserted into the kennel.

13. The kennel improvement system according to claim 12, wherein
the padded surface includes a front area including waterproof material.

14. The kennel improvement system according to claim 12, wherein
the padded surface includes a recessed area configured to accept a feeding bowl.

15. The kennel improvement system according to claim 12, wherein
the padded surface includes clips to couple to the kennel.

16. The kennel improvement system according to claim 12, wherein
the padded surface includes a cutout.

17. The kennel improvement system according to claim 12, further comprising
an attachment device comprising a flange configured to attach to the kennel and a feeding portion.

18. The kennel improvement system according to claim 12, wherein
the padded surface includes a bottom surface and at least two side surfaces, the two side surfaces being movable so as to a first position transverse to the bottom surface and a second position generally parallel to the bottom portion.

19. The kennel improvement system according to claim 18, wherein
the two side surfaces are hingedly attached to the bottom surface.

20. The kennel improvement system according to claim 12, wherein
at least a portion of the padded surface is waterproof.
